(19) United States
(12) Patent Application Publication
(10) Pub. No.: US 2002/0169936 A1
(43) Pub. Date: Nov. 14, 2002

(54) Optimized page tables for address translation

(76) Inventor: Nicholas J.N. Murphy, Surrey (GB)

Correspondence Address: LANCE D. REICH, ESQ., BOCKHOP & REICH, LLP, 3235 SATELLITE BLVD., BLDG. 400, SUITE 300, DULUTH, GA, 30096, US

(21) Appl. No.: 09/731,056

(22) Filed: Dec. 6, 2000

Related U.S. Application Data
(60) Provisional application No. 60/169,060, filed on Dec. 6, 1999.

(51) Int. Cl. G06F 12/00

(52) U.S. Cl. 711/205

(57) ABSTRACT

A virtual memory page table wherein each entry specifies the size of an optional larger block of pages which is optionally associated with any particular page. This achieves a backward-compatible way to achieve variable page size with minimal added overhead.

### CROSS-REFERENCE TO OTHER APPLICATION

This application claims priority from U.S. provisional application No. 60/169,060 filed Dec. 6, 1999, which is hereby incorporated by reference.

### BACKGROUND AND SUMMARY OF THE INVENTION

The present invention relates to translation lookaside buffer architectures, and particular to applications of these in connection with three-dimensional computer graphics.

One of the basic tools of computer architecture is “virtual” memory. This is a technique which allows application software to use a very large range of memory addresses, without knowing how much physical memory is actually present on the computer, nor how the virtual addresses correspond to the physical addresses which are actually used to address the physical memory chips (or other memory devices) over a bus.

This subject, like many other features of computer architectures, takes on particular twist in the context of computer graphics. It is often convenient for a graphics controller to work within a logical address space that is distinct from the physical memory that data is stored in. Reasons for doing this include having a larger logical address range than there is physical memory, and the ability to scatter physical memory in a non-sequential order to ease allocation.

Address translation is used to map the logical address to the physical address. The mapping is held in a table, and each address to be translated has to be adjusted according to information held in it. To make the size of the table practical, addresses are grouped into “pages,” such that each address can be defined to be part of a page. The address translation tables are therefore called page tables. The page table can hold information beyond address translation, such as page status and validity.

FIG. 2 shows a typical entry definition in a conventional page table. The fields of the entry define the status of the page and the base address in physical memory. If a page is not “resident” (bit 0), then it is not present in the memory, and has to be loaded from somewhere else, e.g. from a disk. If a page is read or written to when a data field (bit 1 or bit 2 respectively) indicates that this is not allowed, a fault is generated so that a controller can handle the error.

FIG. 3 shows a conventional algorithm for determining a physical address from a logical address for a 4K byte page:

1. Step 310: Determine the logical page from the logical address:

LogicalPage=LogicalAddress>>12;

(That is, the logical page number is found by deleting the twelve least significant bits of the logical address. The number of LSBs to be ignored would be different if the page size were larger or smaller than 2¹².)

2. Step 320: Determine the physical page from the logical page

PhysicalPage=PageTable[LogicalPage].Address

3. Step 330: Determine the physical address from the physical page

PhysicalAddress=PhysicalPage+(LogicalAddress & 0x00000FFF)

(That is, the MSBs of the Physical Address are taken from the Physical Page, and the 12 LSBs of the Physical Address are the LSBs of the Logical Address.)

Because each address has to be referenced through the page table, it is common practice to store recently used table entries in a cache, usually referred to as the translation lookaside buffer or “TLB.” Each time a new page is referenced the TLB must be updated, but subsequent accesses within the page can reuse the contents of the TLB for higher performance.

The time taken to update the translation lookaside buffer is generally large compared to the time taken to issue a read or a write to memory, so the frequency of cache misses suffered by the TLB is an important factor in performance. The frequency of cache misses, in turn, is affected by the size of the page.

The size of the page is a compromise between efficiency of memory allocation and efficiency of TLB updates. If the page is made smaller, memory can be allocated with less wastage, but the frequency of TLB misses is higher; if the page size is made larger, memory is allocated less efficiently, but the frequency of TLB misses is lowered.

Ideally, the size of the page would vary according to the needs of the data that memory is being allocated for. A variable size page, however, makes managing the page table very complex. If the page size is not fixed, it is not possible to determine the physical page by simply indexing into an array as shown above; instead, the page table would presumably have to be traversed until the correct entry is found.

Some further general discussion of memory management can be found in Hennessy & Patterson, Computer Architecture: a Quantitative Approach (2.ed. 1996); Przybylski, Cache and Memory Hierarchy Design (1990); Subieta, Object-based Virtual Memory for PCs (1990); Carr, Virtual Memory Management (1984); Hwang and Briggs, Computer Architecture and Parallel Processing (1984); Loshin, Efficient Memory Programming (1998); Lau, Performance Improvement of Virtual Memory Systems (1982); and Handy, The Cache Memory Book (1998); all of which are hereby incorporated by reference. The hypertext tutorial which starts at http://cne.gmu.edu/Modules/VM/ is also hereby incorporated by reference. Another useful online resource is found at http://www.harlequin.com/mm/reference/faq.html, and this too is hereby incorporated by reference. Much current work can be found in the annual proceedings of the ACM International Symposium on Memory Management (ISMM), which are all hereby incorporated by reference.

Optimized Page Tables for Address Translation

The present application discloses an architecture which reduces the effect of TLB misses by effectively varying the size of the pages WITHOUT increasing the complexity of the lookup algorithm. This is done by adding a page-size specifier to the conventional fields in the page table itself. This provides a convenient upgrade compatibility: software which is not aware of the page-size specifier can simply access memory in fixed-page-size units, just as in conventional systems; but software which IS aware of the page-size specifier can treat the specified blocks of pages as a single unit, and thus achieve more efficient operation. Every page still has an entry, but the page-size specifier can be used for further optimization by software which is capable of it.

In a preferred class of embodiments, the blocks of 2ⁿ fixed-size pages are always aligned to the corresponding address boundary, so that there is never any question about the position of a fixed-size page within its respective block of pages.

In one particular class of embodiments this is used in combination with graphics acceleration, for frame buffer storage and/or texture management. This modified TLB architecture is particularly advantageous for frame buffer management, since the frame buffer is typically large, locked down, and contiguous.

### BRIEF DESCRIPTION OF THE DRAWING

The disclosed inventions will be described with reference to the accompanying drawings, which show important sample embodiments of the invention and which are incorporated in the specification hereof by reference, wherein:

FIG. 1 shows the format of a page table according to the presently preferred embodiment.

FIG. 2 shows a typical entry definition in a conventional page table.

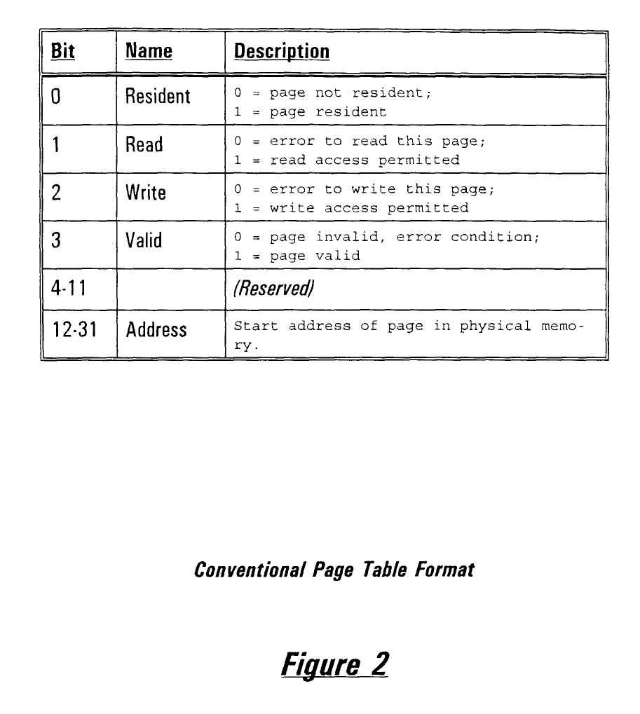

FIG. 3 shows a conventional algorithm for determining a physical address from a logical address for a 4 Kbyte page.

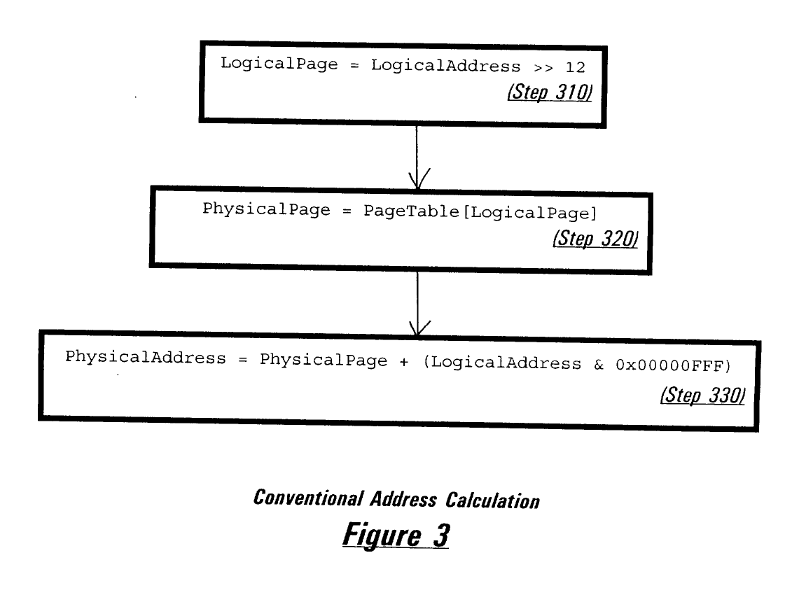

FIG. 4A is an overview of a computer system, with a rendering subsystem, which can advantageously incorporate the disclosed innovations.

FIG. 4B is a block diagram of a 3D graphics accelerator subsystem, which can advantageously incorporate the disclosed innovations.

### DETAILED DESCRIPTION OF THE PREFERRED EMBODIMENTS

The numerous innovative teachings of the present application will be described with particular reference to the presently preferred embodiment (by way of example, and not of limitation).

This invention reduces the effect of TLB misses by effectively varying the size of the pages without increasing the complexity of the lookup algorithm. In this example the basic page size is 4K bytes and each 4K page has its own page table entry, with the Address field giving the start address of that 4K page in physical memory. The PageSize field in the page table provides further information about allocation, indicating that a number of 4K pages are allocated consecutively and start on a suitable boundary. For example, if the PageSize field has the value “2” it indicates this page is one of a group of four consecutive 4K byte pages in physical memory, and also that the logical and physical start addresses of this 16K “page” are aligned to a 16K byte boundary. The PageSize field allows address translation hardware to optimize reading of the page tables and reduce the number of TLB updates, although the hardware can choose to ignore this information and will still operate correctly (because the Address field always contains the correct start address for each individual 4K page, regardless of any PageSize information).

Hence if the memory allocation algorithm is able to allocate consecutive 4K pages the page table can hold this information and the effective page size is changed, but the physical page address can always be determined by a simple lookup into the table.

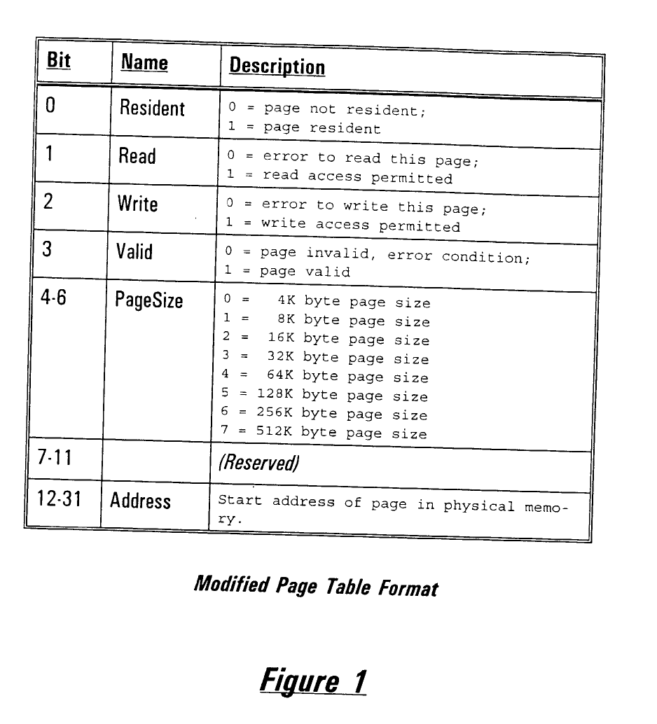

FIG. 1 shows the format of a page table according to the presently preferred embodiment. In this example three bits (bits 4-6) are allocated to the PageSize specifier, so that a page can be specified not to be part of a larger block of pages, or to belong to any one of seven possible larger block sizes.

Note that the page size is actually defined by the page table entry, although the TLB, or the memory management unit (MMU) that the TLB is part of, has to understand the page size.

Note also that, in preferred embodiments, there is an entry in the page table for every page (of the standard size). Address translation can still be done by the direct indexing methods used in the prior art, but a further optimization is available, without speed penalty, by understanding that any subsequent address within the block of pages defined by that entry can use the same table entry.

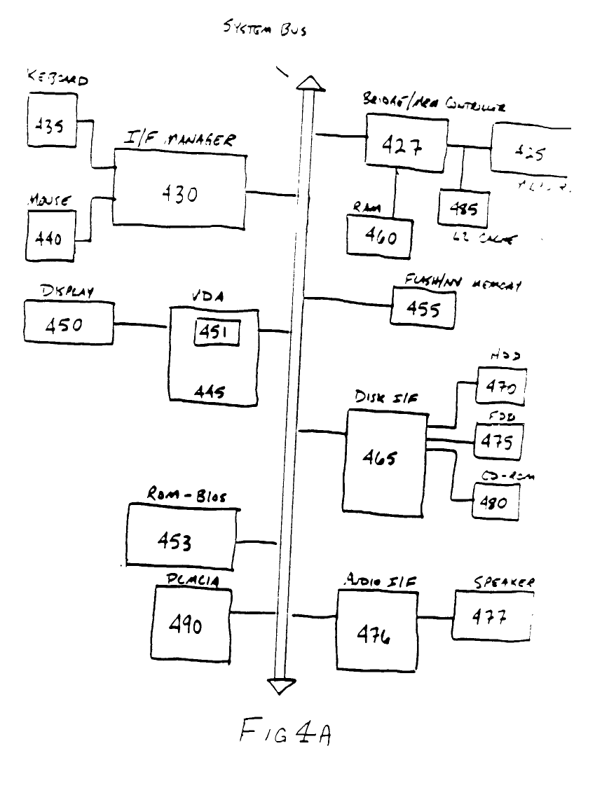

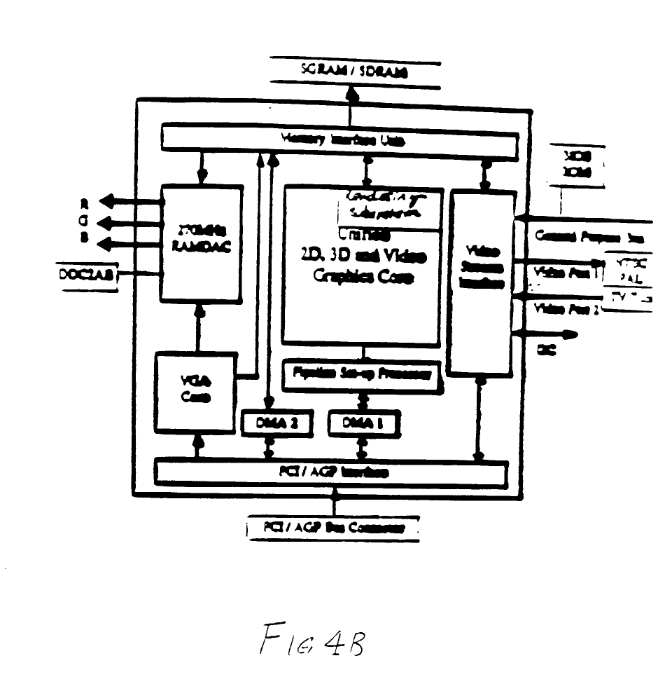

FIG. 4A is an overview of a computer system, with a rendering subsystem, which can advantageously incorporate the disclosed innovations. However, it should be understood that the disclosed innovations can optionally be included in a large variety of computing systems, and neither the details nor the scale of the claimed systems are delimited by this Figure. The complete computer system includes in this example: user input devices (e.g. keyboard 435 and mouse 440); at least one microprocessor 425 which is operatively connected to receive inputs from the input devices, across e.g. a system bus 431, through an interface manager chip 430 which provides an interface to the various ports and registers; the microprocessor interfaces to the system bus through perhaps a bridge controller 427; a memory (e.g. flash or non-volatile memory 455, RAM 460, and BIOS 453), which is accessible by the microprocessor; a data output device (e.g. display 450 and video display adapter card 445) which is connected to output data generated by the microprocessor 425; and a mass storage disk drive 470 which is read-write accessible, through an interface unit 465, by the microprocessor 425.

Optionally, of course, many other components can be included, and this configuration is not definitive by any means. For example, the computer may also include a CD-ROM drive 480 and floppy disk drive (“FDD”) 475 which may interface to the disk interface controller 465. Additionally, L2 cache 485 may be added to speed data access from the disk drives to the microprocessor 425, and a PCMCIA 490 slot accommodates peripheral enhancements. The computer may also accommodate an audio system for multimedia capability comprising a sound card 476 and a speaker(s) 477.

FIG. 4B is a block diagram of a 3D graphics accelerator subsystem, which can advantageously incorporate the disclosed innovations. However, it should be understood that the disclosed innovations can optionally be included in a large variety of graphics systems, and neither the details nor the scale of the claimed systems are delimited by this Figure. A sample board incorporating the P3™ graphics processor may include: the P3™ graphics core itself; a PCI/AGP interface; DMA controllers for PCI/AGP interface to the graphics core and memory; SGRAM/SDRAM, to which the chip has read-write access through its frame buffer (FB) and local buffer (LB) ports; a RAMDAC, which provides analog color values in accordance with the color values read out from the SGRAM/SDRAM; and a video stream interface for output and display connectivity. FIGS. 4A and 4B are both described in detail in commonly owned and copending U.S. patent application Ser. No. 09/591,231 filed Jun. 6, 2000, which is hereby incorporated by reference in its entirety.

According to a disclosed class of innovative embodiments, there is provided: A virtual memory page table, comprising: a plurality of logical page addresses separated by substantially constant increments; and, for each respective one of said logical page addresses: a corresponding physical page address; and a specifier for a block of pages, including said respective logical page address, which can be treated as a single unit of pages.

According to another disclosed class of innovative embodiments, there is provided: A virtual memory system, comprising: a page table, which defines a mapping from a plurality of logical page addresses to a respective plurality of physical page addresses; wherein said table specifies, for respective ones of said logical page addresses, a variable size block of page addresses including said respective logical page address; and memory management logic which, after ascertaining said mapping for at least one logical page address, reuses said mapping, in at least some cases, for a different logical page address which falls within said block specified at said one logical page address.

According to another disclosed class of innovative embodiments, there is provided: A virtual memory system, comprising: a page table, which defines a mapping from a plurality of logical page addresses to a respective plurality of physical page addresses; wherein said table specifies, for respective ones of said logical page addresses, a variable size block of page addresses including said respective logical page address; a translation lookaside buffer, which provides caching for said page table; and memory management logic which, after ascertaining said mapping for at least one logical page address, reuses said mapping, in at least some cases, for a different logical page address which is not present in said translation lookaside buffer but which falls within said block specified at said one logical page address.

According to another disclosed class of innovative embodiments, there is provided: A data processing method, comprising the steps of: translating logical page addresses into corresponding physical address pages, using a page table which is cached by a translation lookaside buffer; wherein said page table specifies, for at least one said logical page address, the quantity of pages which are to be handled, together with said logical address, as a single block.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

For one example, it is contemplated that the possible sizes of multipage blocks can optionally be scaled in powers of 4 rather than powers of 2.

For another example, it is contemplated that the possible sizes of multipage blocks can optionally be scaled in a non-log-linear way, using powers of 4 in the lower range and powers of 2 in the upper range.

For another example, it is contemplated that the possible sizes of multipage blocks can also optionally be scaled in other ways as well.

For another example, the number of bits used to specify the size of a larger block of pages can be more or less than three. In one example, if only two bits are used, the three available block sizes (besides unity) can be, for example, 16, 256, or 4K minimum-size pages.

Additional general background, which helps to show variations and implementations, may be found in the following publications, all of which are hereby incorporated by reference: Advances in Computer Graphics (ed. Enderle 1990); Angel, Interactive Computer Graphics: A Top-Down Approach with OpenGL; Angell, High-Resolution Computer Graphics Using C (1990); the several books of “Jim Blinn's Corner” columns; Computer Graphics Hardware (ed. Reghbati and Lee 1988); Computer Graphics: Image Synthesis (ed. Joy et al.); Eberly, 3D Game Engine Design (2000); Ebert, Texturing and Modelling 2.ed. (1998); Foley et al., Fundamentals of Interactive Computer Graphics (2.ed. 1984); Foley, Computer Graphics Principles & Practice (2.ed. 1990); Foley, Introduction to Computer Graphics (1994); Glidden, Graphics Programming With Direct3D (1997); Hearn and Baker, Computer Graphics (2.ed. 1994); Hill: Computer Graphics Using OpenGL; Latham, Dictionary of Computer Graphics (1991); Tomas Moeller and Eric Haines, Real-Time Rendering (1999); Michael O'Rourke, Principles of Three-Dimensional Computer Animation; Prosise, How Computer Graphics Work (1994); Rimmer, Bit Mapped Graphics (2.ed. 1993); Rogers et al., Mathematical Elements for Computer Graphics (2.ed. 1990); Rogers, Procedural Elements For Computer Graphics (1997); Salmon, Computer Graphics Systems & Concepts (1987); Schachter, Computer Image Generation (1990); Watt, Three-Dimensional Computer Graphics (2.ed. 1994, 3.ed. 2000); Watt and Watt, Advanced Animation and Rendering Techniques: Theory and Practice; Scott Whitman, Multiprocessor Methods For Computer Graphics Rendering; the SIGGRAPH Proceedings for the years 1980to date; and the IEEE Computer Graphics and Applications magazine for the years 1990 to date. These publications (all of which are hereby incorporated by reference) also illustrate the knowledge of those skilled in the art regarding possible modifications and variations of the disclosed concepts and embodiments, and regarding the predictable results of such modifications.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

What is claimed is:

1. A virtual memory page table, comprising:
a plurality of logical page addresses separated by substantially constant increments; and, for each respective one of said logical page addresses:
a corresponding physical page address; and
a specifier for a block of pages, including said respective logical page address, which can be treated as a single unit of pages.

2. The table of claim 1, further comprising, for each respective one of said logical page addresses, read and write permission flags.

3. The table of claim 1, further comprising, for each respective one of said logical page addresses, at least one validity flag.

4. A virtual memory system, comprising:
a page table, which defines a mapping from a plurality of logical page addresses to a respective plurality of physical page addresses;
wherein said table specifies, for respective ones of said logical page addresses, a variable size block of page addresses including said respective logical page address;
and memory management logic which, after ascertaining said mapping for at least one logical page address, reuses said mapping,
in at least some cases,
for a different logical page address
which falls within said block specified at said one logical page address.

5. The system of claim 4, further comprising memory management logic which updates said translation lookaside buffer in such a way that all of said quantity of pages are updated together.

6. The system of claim 4, further comprising at least one CPU and at least one graphics processing subsystem, and wherein said one logical page address is part of a frame buffer accessed by said graphics processing subsystem.

7. A virtual memory system, comprising:
a page table, which defines a mapping from a plurality of logical page addresses to a respective plurality of physical page addresses;
wherein said table specifies, for respective ones of said logical page addresses, a variable size block of page addresses including said respective logical page address;
a translation lookaside buffer, which provides caching for said page table;
and memory management logic which, after ascertaining said mapping for at least one logical page address, reuses said mapping,
in at least some cases,
for a different logical page address
which is not present in said translation lookaside buffer
but which falls within said block specified at said one logical page address.

8. The system of claim 7, further comprising memory management logic which updates said translation lookaside buffer in such a way that all of said quantity of pages are updated together.

9. The system of claim 7, further comprising at least one CPU and at least one graphics processing subsystem, and wherein said one logical page address is part of a frame buffer accessed by said graphics processing subsystem.

10. A data processing method, comprising the steps of:
translating logical page addresses into corresponding physical address pages, using a page table which is cached by a translation lookaside buffer;
wherein said page table specifies, for at least one said logical page address, the quantity of pages which are to be handled, together with said logical address, as a single block.

11. The method of claim 10, wherein, under at least some conditions,
a subsequently received logical page address, which is not present in said translation lookaside buffer,
is directly translated into the physical page address for said one logical page address,
IF said subsequently received logical page address falls within said block specified by said page table for said one logical page address.

12. The method of claim 10, wherein said virtual address is part of a frame buffer accessed by a graphics processing subsystem.
